(19) United States
(12) Patent Application Publication
(10) Pub. No.: US 2007/0198345 A1
(43) Pub. Date: Aug. 23, 2007

(54) Method and system for creating profit using personal website

(75) Inventor: Yon-Ho Park, Daejeon-Si (KR)

Correspondence Address: DITTHAVONG MORI & STEINER, P.C., 918 Prince St., Alexandria, VA, 22314, US

(73) Assignee: NR Systems, Inc., Seoul (KR)

(21) Appl. No.: 11/511,165

(22) Filed: Aug. 28, 2006

Related U.S. Application Data
(63) Continuation-in-part of application No. 11/401,844, filed on Apr. 12, 2006.

(30) Foreign Application Priority Data
Feb. 20, 2006 (KR) KR10-2006-16449
Jun. 1, 2006 (KR) KR10-2006-49608

(51) Int. Cl. G06Q 30/00

(52) U.S. Cl. 705/14

(57) ABSTRACT

The present invention relates, in general, to a method and system for generating profit using a personal website and, more particularly, to a method and system for generating profit using a personal website, which automatically post an advertisement or a news item suitable for the characteristics of each personal website provided in a member client or each personal website provided in an information provision server, on the personal website, and enable a member, operating the personal website, to generate profit.

Therefore, the present invention provides advertisements suitable for the characteristics of personal websites, thus providing a new source of profit to member clients operating the personal websites.

### BACKGROUND OF THE INVENTION

1. Field of the Invention

The present invention relates, in general, to a method and system for generating profit using a personal website and, more particularly, to a method and system for generating profit using a personal website, which automatically post an advertisement or a news item suitable for the characteristics of each personal website provided in a member client or each personal website provided in an information provision server, on the personal website, and enable a member, operating the personal website, to generate profit.

2. Description of the Related Art

On conventional personal websites having the same domain name, data, such as pictures, text or moving images, is mutually exchanged between the websites through service groups, such as special interest groups, social clubs or expert knowledge groups.

However, the conventional technology is disadvantageous in that it only enables information exchange, but does not provide a method of generating profit, so that there is little motive to spend a lot of energy creating personal websites.

In order to overcome such a disadvantage, technology for posting advertisements on a personal website and generating profit has been developed. However, such a technology is problematic in that, since a server for managing personal websites and a server for providing advertisements are separately provided, the posting of advertisements on personal websites is difficult, and the procedure for posting advertisements is complicated and is not automated, so that persons having no professional technical skill in the art cannot easily post advertisements.

Further, the conventional technology is also problematic in that, since personal websites currently provided by most portal websites do not have authority to access a web server, not even experts having professional technical skill in the art can post advertisements.

### SUMMARY OF THE INVENTION

Accordingly, the present invention has been made keeping in mind the above problems occurring in the prior art, and an object of the present invention is to provide a method and system that automatically post an advertisement or a news item suitable for the characteristics of each personal website constructed in a member client or each personal website constructed in an information provision server, on the personal website, and enable a member, operating the personal website, to generate profit using the advertisement or news item.

In accordance with one embodiment of the present invention to accomplish the above object, there is provided a method of generating profit using an advertising system using a personal website, comprising the steps of installing a program required to create a personal website in a member client, the member client operating a personal website provided by an information provision server and transmitting information about the personal website to the information provision server, the information provision server organizing information about the personal website into a database, the information provision server analyzing an advertisement requested by an advertiser client and transmitting an analyzed advertisement to a database (DB), transmitting the advertisement, which has been transmitted to and stored in the DB, to a personal website suitable for characteristics of the advertisement and posting the advertisement, an Internet user client accessing the information provision server and searching for personal websites, selecting any one from among found personal websites and accessing the selected personal website, the information provision server counting the number of clicks on the advertisement while the Internet user client, having accessed the personal website, clicks the posted advertisement and goes to an advertiser website via the information provision server, and the information provision server transmitting part of an advertisement charge received from the advertiser client to the member client depending on the number of clicks.

According to one embodiment of the present invention, the step of installing the program in the member client may be performed so that a program allowing the information provision server and the personal website, operated by the member client, to have the same domain name is installed.

According to one embodiment of the present invention, the step of transmitting an advertisement to the personal website and posting the advertisement may be performed so that, if information about the personal website is changed, an advertisement or a news item suitable for the changed information is posted on the personal website.

According to one embodiment of the present invention, the step of transmitting an advertisement to the personal website and posting the advertisement may be performed so that the information provision server simultaneously posts advertisements or news items to be posted on a plurality of personal websites having similar characteristics through a single process.

According to one embodiment of the present invention, the advertisement or news item may be displayed in any one specific frame of the personal website.

According to one embodiment of the present invention, the step of selecting and accessing any one personal website may be performed to access the website using a dynamic IP address of the personal website.

According to one embodiment of the present invention, the step of selecting and accessing any one personal website may be performed to directly access the personal website using a Uniform Resource Locator (URL) of the personal website.

In accordance with a further embodiment of the present invention to accomplish the above object, there is provided a method of generating profit using a personal website, comprising the steps of constructing an information provision server to drive a plurality of personal websites, a plurality of member clients accessing a hosting unit, provided in the information provision server, and operating the plurality of personal websites, storing and arranging information about the plurality of operated personal websites in a database (DB) of the information provision server, and storing and arranging advertisements or news items provided by advertiser clients in the DB of the information provision server, a web crawler, provided in an application unit of the information provision server, collecting information stored in the DB of the information provision server, analyzing the collected information about the personal websites, and transmitting an extracted advertisement or news item to the hosting unit, thus posting the advertisement or news item in an advertisement space of a corresponding personal website, an Internet user client searching for personal websites operated by a plurality of member clients, having the posted advertisement or news item, using the information provision server, selecting a personal website operated by an arbitrary member client from among the found personal websites operated by the plurality of member clients, and accessing the selected personal website, the Internet user client clicking and reading the posted advertisement or news item, and distributing profit, generated by the information provision server, to the member clients operating the personal websites as the advertisement or news item is read.

According to another embodiment of the present invention, the web crawler provided in the application unit may analyze information posted on a corresponding personal website and extract an advertisement or a news item suitable for the personal website from the DB provided in the information provision server.

According to another embodiment of the present invention, the advertisement space of each personal website may be constructed so that an advertisement or a news item, extracted from the DB of the information provision server by the web crawler, and an advertisement or a news item, extracted from the DB of the information provision server to correspond to letters, numerals and symbols input to an activation window, are posted in the advertisement space.

According to another embodiment of the present invention, the activation window may be displayed in the advertisement space of the personal website through selection of random advertisements.

According to another embodiment of the present invention, the step of distributing profit, generated by the information provision server, to the member clients operating the personal websites as the advertisement or news item is read, may be performed so that the plurality of member clients is paid advertisement charges by the information provision server depending on the number of clicks on a corresponding advertisement by the Internet user client.

According to another embodiment of the present invention, the advertisement charges may be distributed so that, as an advertisement or a news item is posted in the advertisement space of each personal website, the plurality of member clients is paid advertisement charges by the information provision server using a flat rate system.

According to another embodiment of the present invention, the advertisement charges may be distributed in such a way that an advertisement charge is distributed by the information provision server to a member client who has clicked an advertisement or a news item, having an event, posted on a personal website, and has executed the event, in an increased ratio.

According to another embodiment of the present invention, the plurality of personal websites may have the same domain name.

In accordance with yet another embodiment of the present invention to accomplish the above object, there is provided a system for generating profit using a personal website, comprising a plurality of advertiser clients for requesting posting of advertisements or news items on personal websites and providing advertisement charges for the advertisements or news items, a plurality of member clients for operating personal websites, on which an advertisement or a news item suitable for characteristics of the personal websites among the advertisements or news items is posted in advertisement spaces, the member clients being paid advertisement charges as the advertisements or news items are posted, a plurality of Internet user clients for accessing a personal website, operated by an arbitrary member client found in the plurality of member clients, and reading the posted advertisement or news item, and an information provision server for receiving advertisements or news items and advertisement charges from the plurality of advertiser clients, automatically providing an advertisement or a news item suitable for characteristics of each personal website to the personal websites, searching for member clients operating the personal websites, and distributing the advertisement charges to the member clients.

According to yet another embodiment of the present invention, the information provision server may comprise a hosting unit for managing the personal websites having advertisement spaces, a data reception unit for receiving information posted on the personal websites and member information about the member clients, a database (DB) for storing therein the received information posted on the personal websites and the member information, an application unit including a web crawler for extracting an advertisement or a news item suitable for characteristics of a corresponding personal website from the information stored in the database, and matching the extracted advertisement or news item with the personal websites, a search engine for searching for personal websites and advertisements or news items matching a keyword, entered by the Internet user clients, and a profit distribution engine for distributing advertisement charges, and a data transmission unit for transmitting the advertisement or news item, suitable for characteristics of the personal website, to the hosting unit.

According to yet another embodiment of the present invention, the hosting unit may comprise a data reception unit for receiving the advertisements or news items transmitted from the information provision server and receiving information to be posted on the personal websites from the member clients, a database (DB) for storing the received advertisements or news items and the information posted on the personal websites, a web server for operating the personal websites using the advertisements or news items stored in the DB and the information posted on the personal websites, and a data transmission unit for transmitting the information stored in the DB and posted on the personal websites to the DB of the information provision server.

According to yet another embodiment of the present invention, the web crawler provided in the application unit may analyze information posted on the personal websites and extract an advertisement or news item suitable for a corresponding personal website from the DB provided in the information provision server.

According to yet another embodiment of the present invention, each personal website may include an activation window enabling random advertisements, or advertisements according to input of letters, numerals and symbols, to be posted in the advertisement space of the personal website.

According to yet another embodiment of the present invention, the advertisement space may be designed so that the advertisement or news item suitable for the personal website, extracted from the DB of the information provision server by the web crawler, and an advertisement or a news item extracted from the DB of the information provision server using letters, numerals or symbols input to the activation window, are posted in the advertisement space.

According to yet another embodiment of the present invention, the activation window may be displayed in the advertisement space of the personal website through selection of random advertisements.

According to yet another embodiment of the present invention, the profit distribution engine may distribute advertisement charges from the information provision server to the member clients depending on the number of clicks by respective Internet user clients on a corresponding advertisement.

According to yet another embodiment of the present invention, the profit distribution engine may distribute advertisement charges from the information provision server to the member clients using a flat rate system as the advertisement or news item is posted in the advertisement space of the personal website.

According to yet another embodiment of the present invention, the profit distribution engine may distribute the advertisement charges from the information provision server to a member client who has clicked an advertisement or a news item, having an event, posted on a personal website, and has executed the event.

According to yet another embodiment of the present invention, the plurality of personal websites may have the same domain name each other.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of an advertising system using a personal website according to one embodiment of the present invention;

FIG. 2 is a diagram showing an example of personal website operated in member client according to one embodiment of the present invention;

FIG. 3 is a diagram showing an example of the results of a search of personal websites according to one embodiment of the present invention;

FIG. 4 is a block diagram of the information provision server of the FIG. 1 according to the present invention;

FIGS. 5a and 5b are flowcharts of a method of generating profit using a personal website according to one embodiment of the present invention;

FIGS. 6a and 6b are flowcharts of a method of generating profit using a personal website according to another embodiment of the present invention;

FIG. 7 is a diagram showing the construction of a system for generating profit using a personal website according to another embodiment of the present invention;

FIG. 8 is a block diagram of the information provision server of the FIG. 7 of the present invention; and

FIG. 9 is a diagram showing an example of a personal website operated by the information provision server according to another embodiment of the present invention.

### DESCRIPTION OF THE PREFERRED EMBODIMENTS

Hereinafter, embodiments of the present invention will be described in detail with reference to the attached drawings.

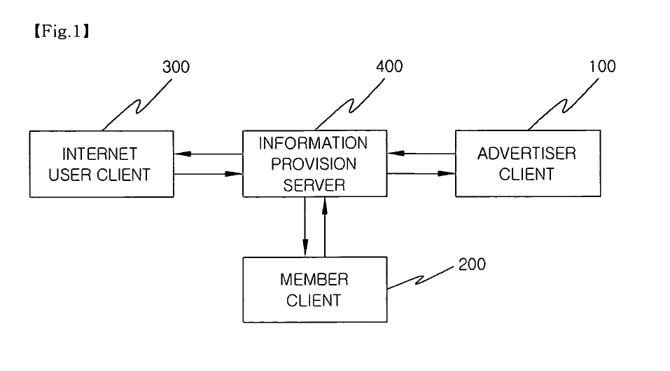

FIG. 1 is a block diagram of an advertising system using a personal website according to one embodiment of the present invention. The advertising system includes a plurality of advertiser clients 100, a plurality of member clients 200, a plurality of Internet user clients 300, and an information provision server 400. The advertising system provides personal websites to Internet users, provides advertisements or news items suitable for the characteristics of the personal websites, and provides a certain percentage of advertisement charges of advertisers, for providing advertisements or news items, to members who operate personal websites, thus generating profit. In particular, according to the circumstances, the Internet user clients 300 may be the member clients 200 of the present invention, and the member clients 200 may be the Internet user clients 300.

In detail, said advertiser client 100 provides advertisements or news items to the information provision server 400, and pays an advertisement charge for the provision of the advertisements or news items to the information provision server 400. Moreover, the advertisements or news items provided by the advertiser client 100 are automatically posted in any one specific frame of a corresponding personal website that is provided by the information provision server 100 to the member client 200. In particular, the advertisement charge is paid using an online payment means.

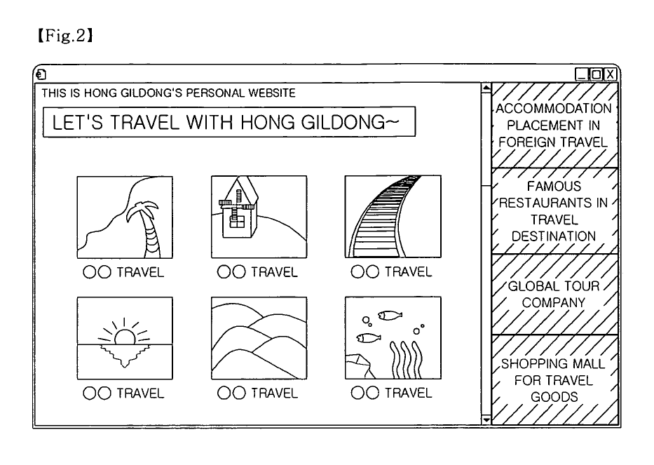

Each member client 200 is provided with a personal website managed by the information provision server 400, and creates the website according to the characteristics of a member, as shown in FIG. 2. Further, the member client 200 receives an advertisement or a news item suitable for the characteristics of the personal website from the information provision server 400, and automatically posts the advertisement or news item in any one portion of the personal website that is created according to the characteristics of the member. That is, the information provision server 400 organizes advertisements received from the plurality of advertiser clients 100 into a database, automatically transmits an advertisement or a news item suitable for the characteristics of the personal website, among the advertisements or news items stored in the database, to the personal website, and then allows the advertisement or news item to be posted. In particular, the personal website regularly transmits information about the website to the information provision server 400 at regular intervals. This procedure is performed by a web crawler of an application unit 430 provided in the information provision server 400.

Therefore, if information about the personal website operated by the member client 200 is changed, the advertisement or news item posted on the personal website is also automatically changed and posted.

Furthermore, if the Internet user client 300 accesses the personal website, individually created by the member, using a dynamic Internet Protocol (IP) address and clicks the advertisement or news item, transmitted from the information provision server 400, the information provision server 400 counts the number of clicks on the advertisement or news item at the same time that the member client 200 goes to the Uniform Resource Locator (URL) of the advertisement or news item via the information provision server 400 without directly going to the URL of the advertisement or news item.

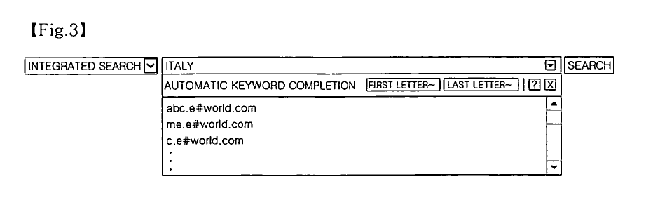

If the Internet user client 300 accesses the information provision server 400 and inputs a keyword, a search engine of the application unit 430 provided in the information provision server 400 is executed. As shown in FIG. 3, the executed search engine outputs a list of personal websites corresponding to the keyword. The output list has the same domain name as the information provision server 400. Further, the Internet user client 300 selects a desired personal website from the output list, and accesses the selected personal website using a dynamic IP address. Moreover, if the Internet user client 300 directly inputs the address of a personal website operated by the member client 200 to the address window of the web browser, the Internet user client goes to the website corresponding to the input address.

Meanwhile, as described above, the member client 200 receives an advertisement charge depending on the number of clicks by the plurality of Internet user clients 300 on advertisements or news items registered on personal websites.

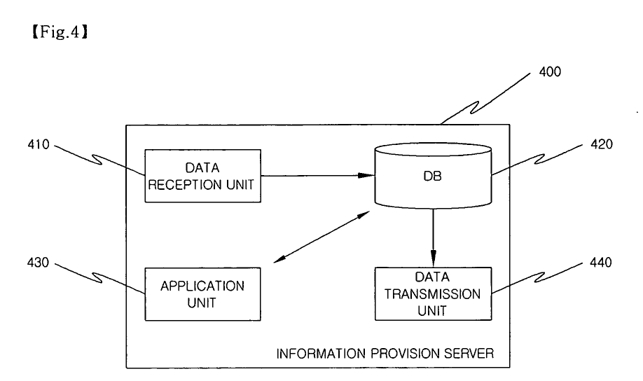

As shown in FIG. 4, the information provision server 400 includes a data reception unit 410, a DB 420, an application unit 430 and a data transmission unit 440. The information provision server 400 provides a personal website to the member client 200, posts an advertisement or a news item of the advertiser client 100, suitable for the characteristics of the personal website, in any one frame of the personal website, receives an advertisement charge from the advertiser client 100 as a fee for posting the advertisement or new item on the personal website, and pays part of the advertisement charge to the operator of the personal website. Further, the information provision server 400 changes the search ranking of personal websites displayed on a search window, depending on the number of times that the Internet user client 300 accesses the corresponding websites.

In more detail, the data reception unit 410 of the information provision server 400 receives a user's personal information from the member client 200 and transmits the user's personal information to the DB 420 so as to utilize a personal website. Further, the data reception unit 410 collects information about the personal website, provided by the information provision server 400 to the member client 200, at any time and updates the DB 420 storing information about the personal website. In this case, the update of the DB 420 is performed by the web crawler. If the information about the personal website is changed by the member, the web crawler collects the changed information, stores the changed information in the DB 420, transmits an advertisement or a news item corresponding to the changed information, and posts the advertisement or news item.

For example, if a member, operating an arbitrary personal website, changes a golf commerce website to a music commerce website while operating the golf commerce website, advertisements or news items related to golf are changed to advertisements or news items related to music.

The personal information includes the characteristics of the operated personal website, as well as personal particulars. Therefore, if a member client 200, operating a personal website related to travel, updates information about a travel destination, preparatory items corresponding to the travel destination, transportation means or sightseeing places, the updated information is updated and registered in the DB 420 of the information provision server 400.

Further, the data reception unit 410 receives advertisements and advertisement charges from the advertiser client 100.

In particular, if the Internet user client 300 clicks an advertisement or a news item posted on the personal website operated by the member client 200, the information provision server 400 receives the number of clicks on the advertisement or news item. The number of clicks is the basis for determining the advertisement charge to be paid.

The DB 420 of the information provision server 400 includes a program DB, a personal information DB, a website component DB, an advertiser DB, and an advertisement click number DB. In detail, the program DB stores a program to be installed in the member client 300 to provide the service of the present invention to Internet users who cannot use a static IP address and a domain service. The personal information DB is organized by receiving information about personal particulars of members or information about personal websites operated by the members from the data reception unit 410 of the information provision server 400. The website component DB stores components required to create personal websites, and the advertiser DB stores information about advertisers for providing advertisements. The advertisement click number DB stores the number of clicks by the Internet user on the advertisement displayed on a corresponding personal website.

The application unit 430 of the information provision server 400 provides a personal website to the member client 200. Since the personal website is individually created by the member, an advertisement or a news item related to the characteristics of the personal website is posted in any one portion of the personal website. Further, advertisements or news items to be displayed on a plurality of relevant personal websites are simultaneously and automatically posted.

In particular, if the Internet user client 300 accesses the personal website using a dynamic IP address and clicks the advertisement or news item, the Internet user client goes to the information provision server 400, without directly going to a webpage corresponding to the URL of the advertisement or news item, thus the number of clicks on the advertisement or news item is counted. Thereafter, the Internet user client goes to the webpage corresponding to the URL of the advertisement or news item.

Moreover, the application unit 430 is provided with a web crawler and a search engine. The web crawler collects information about personal websites at any time, and automatically posts a suitable advertisement or news item in a frame of the personal website, in which the advertisement or news item is to be displayed, on the basis of the collected information.

When the Internet user client 300 accesses the information provision server 400 and inputs a required keyword, the search engine arranges a list of personal websites related to the keyword. That is, a search window of a conventional portal site arranges a plurality of websites which is not operated by the portal site, whereas the present invention is implemented so that, if a keyword is input, personal websites, having the same domain name as the information provision server 400 and related to the keyword, are arranged.

Meanwhile, the application unit 430 analyzes the characteristics of the advertisement, transmitted from the advertiser client 100, organizes advertisements related to the advertisement characteristics into a database, and transmits the organized database to the DB 420.

The data transmission unit 440 of the information provision server 400 transmits the program DB provided in the DB 420 to the member client 200. The programs of the program DB include a program required to allow the member client 200 to be a web server, data and a program required to create a personal website, and a program required to communicate with the information provision server 400. Therefore, the programs are installed in the member client 200 to implement the present invention.

The above-described information provision server 400 has the same domain name as the personal website.

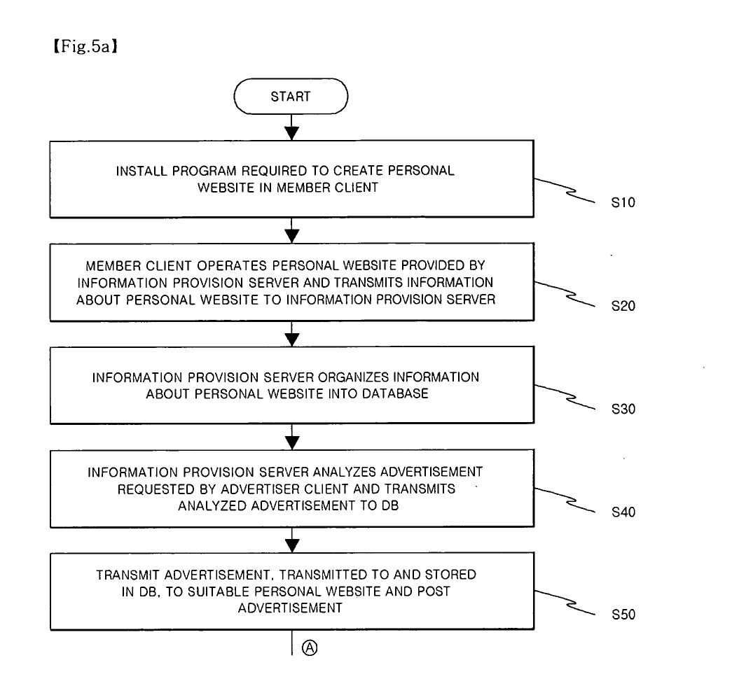

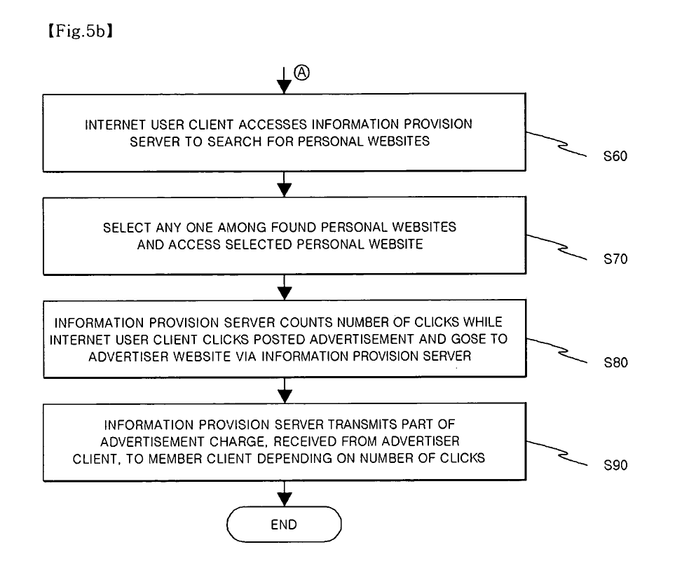

FIGS. 5a and 5b are flowcharts of a method of generating profit using the advertising system using a personal website according to the present invention. The method of generating profit includes the following steps.

That is, the method includes the step S10 of installing a program required to create a personal website in a member client, the step S20 of the member client operating a personal website provided by the information provision server and transmitting information about the personal website to the information provision server, the step S30 of the information provision server organizing information about personal websites into a database, the step S40 of the information provision server analyzing an advertisement requested by the advertiser client and transmitting the analyzed advertisement to the DB, the step S50 of transmitting the advertisement, which has been transmitted to and stored in the DB, to personal websites suitable for the characteristics of the advertisement and posting the advertisement, the step S60 of an Internet user client accessing the information provision server to search for personal websites, the step S70 of selecting any one website from among found personal websites and accessing the selected website, the step S80 of the information provision server counting the number of clicks on the posted advertisement while the Internet user client, having accessed the website, clicks the posted advertisement and goes to an advertiser website via the information provision server, and the step S90 of the information provision server transmitting part of an advertisement charge received from the advertiser client to the member client depending on the number of clicks.

In more detail, the step S10 of installing a program required to create a personal website in the member client is performed so that a program allowing the information provision server 400 and a website operated by the member client 200 to have the same domain name is installed, the member client 200 is a member of the information provision server 400, and the program is provided by the information provision server 400 to create a personal website in the member client 200.

The step S20 of the member client operating the personal website provided by the information provision server and transmitting information about the personal website to the information provision server is performed so that the personal website provided by the information provision server 400 is operated by the member client 200 using the program installed at step S10, and information about the operation of the personal website is collected by the web crawler of the application unit 430 provided in the information provision server 400.

The step S30 of the information provision server organizing information about personal websites into a database is performed so that the web crawler collects information about personal websites at step S20, and organizes the personal website information into a database so as to post an advertisement or a news item suitable for the characteristics of each individual personal website in any one portion of the personal website.

The step S40 of the information provision server analyzing an advertisement requested by the advertiser client and transmitting the analyzed advertisement to the DB is performed after step S30 so that the information provision server 400 determines whether the personal website information and the advertisement or news item requested by a plurality of advertiser clients 100 are related. That is, the information provision server analyzes the requested advertisement, organizes the analyzed advertisement into a database and transmits the advertisement to the DB 420 so as to post the advertisement or news item suitable for the characteristics of a corresponding personal website on the personal website.

The step S50 of transmitting the advertisement, which has been transmitted to and stored in the DB, to a personal website suitable for the characteristics of the advertisement and posting the advertisement on the personal website is performed so that the advertisement or news item, which has been analyzed at step S40 and is suitable for the characteristics of the personal website, is transmitted to be displayed in any one specific frame of the personal website, and is then posted on the personal website.

For example, if an arbitrary member changes a personal website related to travel to a personal website related to golf and operates the golf-related website, the web crawler collects information about golf-related personal websites instead of information about travel-related personal websites. In this way, as the web crawler collects information about personal websites at any time, it determines the characteristics of a corresponding personal website operated by the member.

In particular, since the personal website has the same domain name as the information provision server 400, and is managed by the information provision server 400, advertisements or news items to be posted on a plurality of personal websites having similar characteristics are simultaneously posted through a single process. That is, as shown in FIG. 3, abc, me and c are IDs of members, e#world.com is a domain name, and is equal to the domain name of the information provision server 400. Accordingly, if the members abc, me and c operate personal websites having similar characteristics, advertisements suitable for the characteristics of the personal websites can be simultaneously transmitted at one time.

Further, the members abc, me and c have the same domain name, and are members of the information provision server 400, so that, if information about the personal websites is changed, advertisements or news items corresponding to the changed information are posted on the personal websites.

The step S60 of the Internet user client accessing the information provision server and searching for personal websites is performed so that, if the information provision server 400 posts an advertisement or a news item on a corresponding personal website at step S50, personal websites stored in the DB of the information provision server 400 are arranged, when the Internet user client inputs a keyword to visit a desired personal website.

The step S70 of selecting any one website among found personal websites and accessing the selected personal website is performed so that the Internet user client 300 selects any one website among the personal websites, found and arranged at step S60, and accesses the selected website using a dynamic IP address. Preferably, the Internet user client 300 directly inputs the URL of a corresponding personal website to the address window of the web browser and then accesses the personal website, in addition to access using the dynamic IP address.

The step S80 of the information provision server counting the number of clicks on the advertisement while the Internet user client, having accessed the website, clicks the posted advertisement and goes to an advertiser website via the information provision server is performed so that, if a plurality of Internet user clients 300 clicks any one of the plurality of advertisements posted on the personal websites, the number of clicks on the advertisement is counted by the information provision server 400 at the same time that the Internet user client goes to the advertiser website via the information provision server 400.

The step S90 of the information provision server transmitting part of an advertisement charge received from the advertiser client to the member client depending on the number of clicks is performed so that part of the advertisement charge received from the advertiser client 100 at step S80 is divided according to the number of clicks on the advertisement and is paid to each member client 200 operating the corresponding personal website.

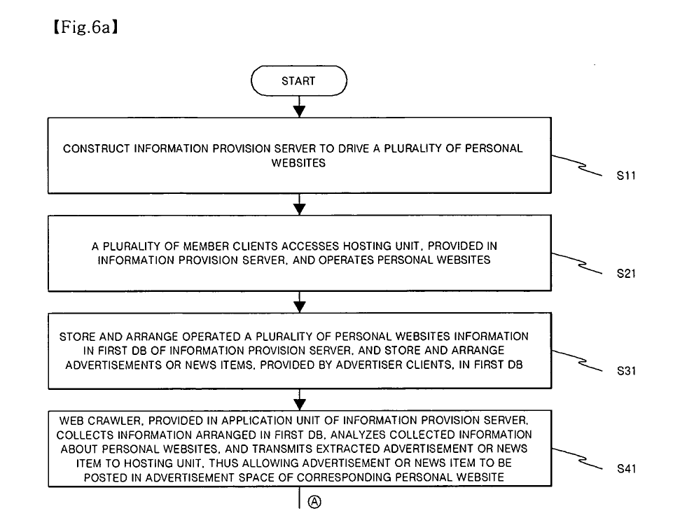

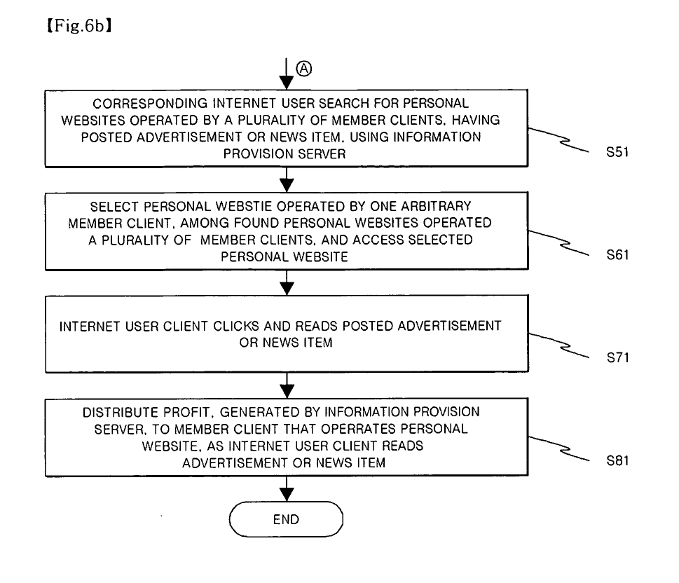

FIGS. 6a and 6b are flowcharts of a method of generating profit using a personal website according to another embodiment of the present invention. The profit generation method performs the following steps.

The profit generation method includes the step S11 of constructing an information provision server to drive a plurality of personal websites, the step S21 of a plurality of member clients accessing a hosting unit, provided in the information provision server, and operating a plurality of personal websites, the step S31 of storing and arranging information about the plurality of operated personal websites in the first database (DB) of the information provision server, and storing and arranging advertisements or news items, provided by advertiser clients, in the first DB, the step S41 of a web crawler, provided in the application unit of the information provision server, collecting the information arranged in the first DB, analyzing the collected information about the personal websites, and transmitting an extracted advertisement or news item to the hosting unit, thus allowing the advertisement or news item to be posted in the advertisement space of a corresponding personal website, the step S51 of a corresponding Internet user client searching for personal websites that are operated by a plurality of member clients, having the posted advertisement or news item, using the information provision server, the step S61 of selecting a personal website operated by one arbitrary member client, among the found personal websites operated by the plurality of member clients, and accessing the selected personal website, the step S71 of the Internet user client clicking and reading the posted advertisement or news item, and the step S81 of distributing profit, generated by the information provision server, to the member client that operates the personal website, when the Internet user client reads the advertisement or news item.

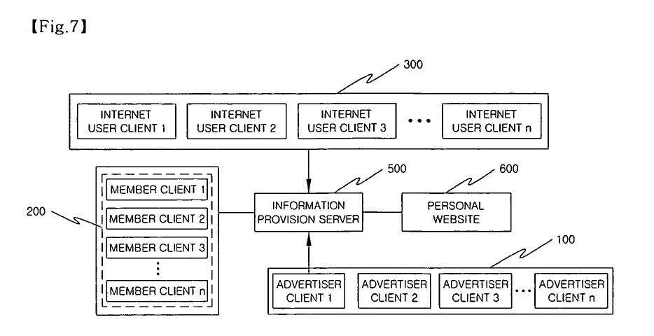

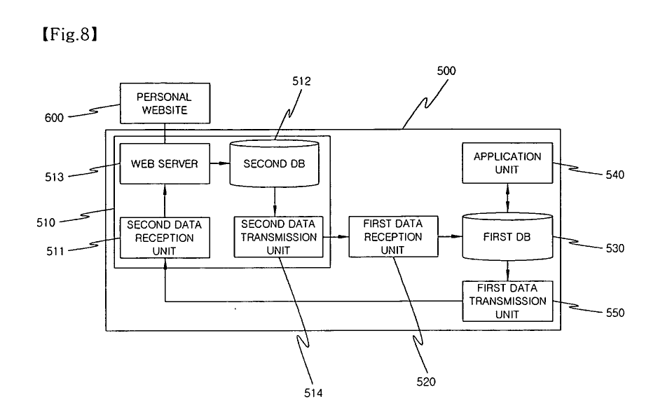

In detail, the step S11 of constructing the information provision server to drive a plurality of personal websites is performed so that an information provision server 500 drives each personal website 600, as shown in FIG. 7. As shown in FIG. 8, the information provision server 500 includes a hosting unit 510 for providing the personal website 600 to allow each member client 200 to operate the personal website 600, a first data reception unit 520 for collecting personal information about the member client 200 and information about the personal website 600, a first DB 530 for storing a plurality of pieces of information collected by the first data reception unit 520, an application unit 540 for storing a plurality of application programs required to drive the information provision server 500, and a first data transmission unit 550 for transmitting an advertisement to the hosting unit 510 so as to post the advertisement stored in the first DB 530 on a personal website 600 matching the advertisement. In particular, the detailed components of the information provision server 500 are described in detail with reference to FIG. 8.

Therefore, in the method of generating profit according to another embodiment of the present invention, the personal website 600 is managed by the hosting unit 510 provided in the information provision server 500, like the step S10 in the embodiment of FIGS. 5a and 5b, in which a program causing the member client 200 to function as a personal web server is provided and installed by the information provision server 400 to drive personal websites.

The step S21 of the plurality of member clients accessing the hosting unit, provided in the information provision server, and operating the plurality of personal websites is performed so that, if the information provision server 500 has been constructed at step S11, each member client 200 first transmits member information about the member client 200 to the first data reception unit 520 of the information provision server 500 and then subscribes as a member, and the information about the member, who has subscribed, is arranged in the first DB 530.

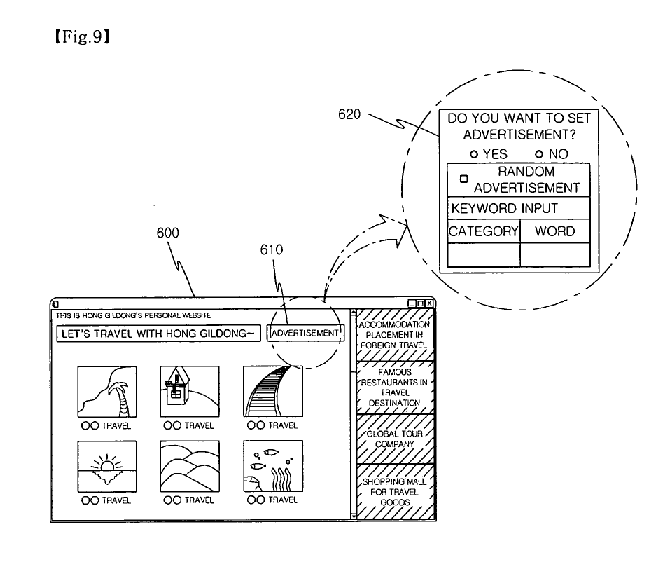

As described above, the plurality of member clients 200, having subscribed as members, accesses the web server 513 of the hosting unit 510, and operates corresponding personal websites, as shown in FIG. 9.

Meanwhile, the personal websites 600 may include personal websites operated by ordinary persons, personal websites operated by persons in the public eye having qualifications in various public fields, such as broadcasting, sports, the press, and politics, and personal websites operated by maniacs having a deep interest in specific fields. The operators of such personal websites are driven by the hosting unit 510 to operate the personal websites 600.

In each personal website 600, an advertisement space is provided, and an advertisement suitable for the characteristics of the operated personal website 600 is preferably posted as an advertisement posted in the advertisement space.

In particular, the plurality of personal websites 600 has the same domain name each other. The reason for having the same domain name in this way is that the information provision server 500 must provide personal websites to a plurality of member clients 200.

Meanwhile, the information provision server 500 may have a domain name other than the domain name of the personal websites having the same domain name. The reason for giving the information provision server 500 a different domain name is that the personal websites are managed by the hosting unit 510. Further, the personal websites 600 and the information provision server 500 may have the same domain name.

Moreover, data required to operate the personal website 600, that is, moving images, music, still images or text posted on the personal websites 600 by the member clients 200, is stored in the second DB 512 of the hosting unit 510, and the second DB 512 is stored in the first DB 530 of the information provision server 500 through the second data transmission unit 514 of the hosting unit 510.

The above-described hosting unit 510 may cause a load due to the number of member clients 200, so a plurality of hosting units 510 may be preferably constructed. Therefore, a plurality of hosting units 510 may be constructed in the information provision server 500, or may be separately provided as additional objects and be linked with the information provision server 500.

The step S31 of storing and arranging information about the plurality of operated personal websites in the first database (DB) of the information provision server, and storing and arranging advertisements or news items, provided by advertiser clients, in the first DB, is performed so that a plurality of pieces of data is transmitted from the second DB 512, in which data required to operate personal websites is stored, to the first data reception unit 520 of the information provision server 500 through the second data transmission unit 514 of the hosting unit 510, and the data transmitted to the second data reception unit 511 is stored in the second DB 512. Further the advertisements or news items provided by the advertiser clients 100 are stored in the first DB 530.

The step S41 of the web crawler, provided in the application unit of the information provision server, collecting the information arranged in the first DB, analyzing the collected information about the personal websites, and transmitting an extracted advertisement or news item to the hosting unit, thus allowing the advertisement or news item to be posted in the advertisement space of a corresponding personal website, is performed so that moving images, music, still images, or and letters indicated in text are collected and analyzed by the web crawler of the application unit 540 from the plurality of pieces of data stored in the database at step S31, and the data stored in the first DB 530 is extracted through the analysis.

For example, if a plurality of moving images or still images is posted on an arbitrary personal website 600, the web crawler collects titles, which are the notes of the moving images or still images, whereas if text is posted on an arbitrary personal website, the web crawler collects letters indicated in the text. The characteristics of the personal website 600 are analyzed using the collected titles or letters, and an advertisement or a news item suitable for the characteristics of the personal website 600 is read from the first DB 530 and is posted in the advertisement space of the personal website 600.

In particular, the method of the web crawler analyzing the characteristics of the personal website 600 using titles and letters is described below with reference to an embodiment.

If the sentence “At the bat for Korea in the top of the eighth inning, the lead-off man Cho Inseong grounded out to third, and Kim Minjae was walked on four balls. He then daringly ran safely to third base when Lee Byeongkyu made a hit to center field and the third baseman Imae caught the ball thrown by center fielder Kinjo but dropped the ball while trying to tag out the runner. Lee Byeongkyu made it safely to second base, thus there was an opportunity, with only one out and men on second and third base. At this time, Japan subbed in Woowan Hujikawa as pitcher. Then captain Lee Jongbeom made a two-base hit to left center field, but Japan had brought their fielders forward to apply pressure to tag the runners out at home base. With a score of 2-0, the bases were cleared. Lee Jongbeom was tagged out while running to third base, and Lee Seungyeop was put out easily” is posted on the personal website 600, the web crawler eliminates special characters, spaces and postpositions from the sentence, and changes verbs and adjectives into words having fundamental forms.

Accordingly, in the above sentence, words from which postpositions are eliminated, and words having fundamental forms, that is, “top of eighth inning, Korea, bat, lead-off man, Cho Inseong, third base, grounder, out, Kim Minjae, four balls, walk, Lee Byeongkyu, hit to center, dare, safe, third baseman, Imae”, etc., remain.

Further, in the first DB 530, categories such as sports, leisure, politics, society, economy, or culture are stored, and words corresponding to the categories are stored.

Therefore, since the word “baseball” is a word related to sports, leisure and culture, a weight of 1 point is added to the categories of sports, leisure and culture. Since the word “Korea” is a word related to politics, society, economy and culture, a weight of 1 point is added to the categories of politics, society, economy and culture. Since the word “bat” is a word related to sports, leisure, society and culture, a weight of 1 point is added to the categories of sports, leisure, society and culture. Since the word “lead-off” is a word related to sports, leisure, society and economy, a weight of 1 point is added to categories of sports, leisure, society and economy.

Using the above method, if the above procedure is repeated with respect to all words appearing in the sentence, a category obtaining the highest weight can be found. The category having the highest weight is determined to be the characteristic of the personal website 600, so that an advertisement or a news item suitable for that category of personal website 600 is posted.

Meanwhile, if the member client 200, operating the personal website 600, clicks an advertisement setting click button 610, as shown in FIG. 9, when an advertisement or a news item is posted, an activation window 620 enabling the setting of an advertisement is displayed.

The activation window 620 is composed of a random advertisement click space enabling random advertisements to be posted in the advertisement space, and a keyword input space enabling a keyword to be input and an advertisement to be posted.

Therefore, if an advertisement has not been set, an advertisement suitable for the characteristics of the personal website 600 is posted, while if an advertisement has been set, the set advertisement is posted.

The step S51 of the Internet user client searching for personal websites that are operated by a plurality of member clients, having the posted advertisement or news item, using the information provision server is performed so that, if a plurality of Internet user clients 300 accesses the information provision server 500 and enters a keyword as the personal website 600 having characteristics is stored in the first DB 530 at step S41, a plurality of personal websites 600 matching the keyword is found in the first DB 530.

Further, if each Internet user client 300 enters a keyword, a plurality of personal websites 600, on which advertisements matching the keyword are posted, is found in the first DB 530.

The step S61 of selecting a personal website operated by one arbitrary member client, among the found personal websites operated by the plurality of member clients, and accessing the selected personal website is performed so that, if a plurality of personal websites 600 has been found at step S51, the Internet user client 300 selects any one personal website 600 among the found personal websites 600, and then accesses the selected personal website 600.

Further, if personal websites 600 on which advertisements matching the keyword are posted are found, the Internet user client selects one among the personal websites and accesses the selected personal website 600.

The step S71 of the Internet user client clicking and reading the posted advertisement or news item is performed so that, if the Internet user client accesses the personal website 600 found at step S61, an advertisement suitable for the characteristics of the personal website 600 is posted, so that the Internet user client 300 goes to a corresponding advertised site via the information provision server 500 by clicking the advertisement.

Meanwhile, the reason for going via the information provision server 500 is to count the number of clicks occurring when the plurality of Internet user clients 300 clicks the advertisement posted in the advertisement space of the personal website 600.

Moreover, when an advertisement, having an event, among advertisements, is read, the results of execution of the event are stored in the advertiser client 100 if the Internet user client 300 executes the event of the advertisement. The stored event execution results are received by the information provision server 500. Therefore, the information provision server 500 provides greater profit to the member client 200 operating the personal website on which the advertisement having the event is posted.

The step S81 of distributing profit, generated by the information provision server, to the member client that operates the personal website, when the Internet user client reads the advertisement or news item, is performed so that, if the advertisement is clicked at step S71, the information provision server 500 counts the number of clicks on the advertisement, and distributes advertisement charges, received from the advertiser clients 100, to the member clients 200, operating the plurality of personal websites 600, using the profit distribution engine provided in the application unit 540 on the basis of the counted number of clicks.

Further, when profit is distributed, the plurality of member clients 200 can be paid advertisement charges by the profit distribution engine that is provided in the application unit 540, using a flat rate system as the advertisement is posted. Alternatively, the member clients 200 can be paid advertisement charges by the profit distribution engine that is provided in the application unit 540 by causing the Internet user client 300 to execute the advertisement, having an event, posted on the personal website 600.

FIG. 7 is a diagram showing the construction of a system for generating profit using a personal website according to another embodiment of the present invention. Similar to FIG. 1 described above, the profit generation system includes a plurality of advertiser clients 100, a plurality of member clients 200, a plurality of Internet user clients 300, and an information provision server 500.

However, because a subject, operating the personal website 600, is changed from the member clients 200 to the information provision server 500, the information provision server 500 includes a hosting unit 510 having a second data reception unit 511, a second DB 512, a web server 513, and a second data transmission unit 514, a first data reception unit 520, a first DB 530, an application unit 540, and a first data transmission unit 550, as shown in FIG. 8.

Therefore, in the present invention, detailed descriptions of the above components, that is, the plurality of advertiser clients 100, the plurality of member clients 200, and the plurality of Internet user clients 300, are omitted, and only the components of the information provision server 500 are described in detail.

The first data reception unit 511 of the hosting unit 510 receives moving images, music, still images or text from the member clients 200, transmits the received moving images, music, still images or text to the second DB 512, and stores them in the second DB 512. Further, the first data reception unit 511 receives advertisements suitable for the characteristics of the personal websites 600, and advertisements set by the activation window 620 enabling the setting of the categories of advertisements, from the first data transmission unit 550 of the information provision server 500.

As shown in FIG. 9, the activation window 620 is activated by clicking the advertisement click button 610 provided on each personal website 600, and includes a random advertisement click space, enabling random advertisements to be posted in an advertisement space, and a keyword input frame, enabling a keyword to be input and an advertisement to be posted.

The second DB 512 of the hosting unit 510 stores therein moving images, music, still images or text received by the second data reception unit 511. The stored moving images, music, still images or text are extracted to be posted on the personal website 600 by the web server 513. Further, the second data transmission unit 550 of the information provision server 500 transmits an advertisement that is suitable for the characteristics of the personal website 600 to the second data reception unit 511 of the hosting unit 510, and stores the transmitted advertisement.

The web server 513 of the hosting unit 510 operates the personal website 600 managed by each member client 200, and posts the moving images, music, still images or text stored in the second DB 512 on the personal website 600.

Meanwhile, as shown in FIG. 9, the personal website 600 may include personal websites operated by ordinary persons, personal websites operated by persons in the public eye having qualifications in various public fields, such as broadcasting, sports, the press, and politics, and personal websites operated by maniacs having a deep interest in specific fields. Since the operators of such personal websites are driven by the hosting unit 510 to operate the personal websites 600, the characteristics of personal websites appear.

Therefore, an advertisement or news item suitable for the characteristics is posted in the advertisement space of each personal website 600. The advertisement posted in the advertisement space through the clicking of the advertisement click button is selected randomly, or by input letters, numerals or symbols.

In particular, the plurality of personal websites 600 has the same domain name each other. The reason for having the same domain name in this way is that the information provision server 500 must provide personal websites to a plurality of member clients 200.

Meanwhile, the information provision server 500 may have a domain name other than the domain name of the personal websites having the same domain name. The reason for giving the information provision server 500 a different domain name is that the personal websites 600 are managed by the hosting unit 510. Further, the personal websites 600 and the information provision server 500 may have the same domain name.

The second data transmission unit 514 of the hosting unit 510 transmits the moving images, music, still images or text, stored in the second DB 512 and posted on the personal websites 600, to the first data reception unit 520 of the information provision server 500.

Since the hosting unit 510 may cause a load due to the number of member clients 200, a plurality of hosting units 510 may be preferably constructed. Therefore, a plurality of hosting units 510 may be constructed in the information provision server 500, or may be separately provided as additional objects and be linked with the information provision server 500.

The first data reception unit 520 receives member information required to allow the member clients 200 to implement the present invention, that is, a name, a resident registration number, an address, and contact information. Further, the first data reception unit 520 receives information posted on the personal websites 600 so as to provide information, which has been received from the second data transmission unit 514 of the hosting unit 510 and has been posted on the personal websites 600 (moving images, music, still images, text, etc.) as advertisements suitable for the advertisement spaces of the personal websites 600, and further receives advertisements or news items from the advertiser clients 100.

The first DB 530 stores member information about the member clients 200 received through the first data reception unit 520, the advertisements or news items provided by the advertiser clients 100, and the moving images, music, still images or text posted on the personal websites 600. Further, the first DB 530 stores therein data that is obtained when the web crawler of the application unit 540 analyzes the moving images, music, still images or text posted on the personal websites 600, matches an advertisement suitable for the characteristics of each personal website 600 with a personal website 600 on which the advertisement is to be posted, and arranges the matching results in a database.

Further, advertisement charges to be paid to respective member clients 200, generating profits through advertisements posted on the personal websites 600, are distributed by the profit distribution engine of the application unit 540, and the distributed advertisement charges are arranged and stored in a database.

The application unit 540 includes the web crawler, a search engine and the profit distribution engine. The web crawler analyzes the moving images, music, still images or text that are stored in the first DB 530 and are posted on the personal websites 600, and extracts an advertisement suitable for the characteristics of the personal websites 600 from the first DB 530, based on analysis results. Further, the web crawler matches the extracted advertisement with a personal website 600, on which the advertisement is to be posted, and arranges and stores the matching results in the first database 530.

The analysis by the web crawler is equal to that of the above embodiment described at step S41.

If a corresponding Internet user client 300 accesses the information provision server 500 and enters a keyword, the search engine searches the first DB 530 for a plurality of personal websites 600 matching the keyword. Further, if the Internet user client 300 enters a keyword, the search engine searches the first DB 530 for personal websites on which an advertisement suitable for keyword is posted.

The profit distribution engine distributes advertisement charges to respective member clients 200 depending on the ratio of the number of clicks on the corresponding advertisement to total advertisement charges to be paid to the member clients 200, distributes preset advertisement charges to respective member clients 200, and distributes an advertisement charge to a member client 200, operating a personal website 600 on which an advertisement having an executed event is posted, at a ratio higher than the preset advertisement charge. Information about distribution performed through the above method is stored in the first DB 530, and advertisement charges are paid to respective member clients 200 using various payment means, based on the distribution information.

The first data transmission unit 550 transmits each advertisement to the first data reception unit 511 of the hosting unit 510 so as to post the advertisement, stored in the first DB 530, on a personal website 600 matching the advertisement.

As described above, the present invention is advantageous in that it provides an advertisement suitable for the characteristics of a personal website, thus providing new profit to a member client operating the personal website.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of generating profit system using a personal website, comprising the steps of:
installing a program required to construct a personal website in a member client;
the member client operating a personal website provided by an information provision server and transmitting information about the personal website to the information provision server;
the information provision server organizing information about the personal website into a database;
the information provision server analyzing an advertisement requested by an advertiser client and transmitting an analyzed advertisement to a database (DB);
transmitting the advertisement, which has been transmitted to and stored in the DB, to a personal website suitable for characteristics of the advertisement and posting the advertisement;
an Internet user client accessing the information provision server and searching for the personal websites;
selecting any one among found personal websites and accessing the selected personal website;
the information provision server counting the number of clicks on the advertisement while the Internet user client, having accessed the personal website, clicks the posted advertisement and goes to an advertiser website via the information provision server; and
the information provision server transmitting part of an advertisement charge received from the advertiser client to the member client depending on the number of clicks.

2. The profit generating method according to claim 1, wherein the step of installing the program in the member client is performed so that a program allowing the information provision server and the personal website, operated by the member client, to have the same domain name is installed.

3. The profit generating method according to claim 1, wherein the step of transmitting an advertisement to the personal website and posting the advertisement is performed so that, if information about the personal website is changed, an advertisement or a news item suitable for the changed information is posted on the personal website.

4. The profit generating method according to claim 3, wherein the step of transmitting an advertisement to the personal website and posting the advertisement is performed so that the information provision server simultaneously posts advertisements or news items to be posted on a plurality of personal websites having similar characteristics through a single process.

5. The profit generating method according to claim 1, wherein the advertisement or news item is displayed in any one specific frame of the personal website.

6. The profit generating method according to claim 1, wherein the step of selecting and accessing the any one personal website is performed to access the website using a dynamic IP address of the personal website.

7. The profit generating method according to claim 1, wherein the step of selecting and accessing the any one personal website is performed to directly access the personal website using a Uniform Resource Locator (URL) of the personal website.

8. A method of generating profit using a personal website, comprising the steps of:
constructing an information provision server to drive a plurality of personal websites;
the plurality of member clients accessing a hosting unit, provided in the information provision server, and operating the plurality of personal websites;
storing and arranging information about the plurality of operated personal websites in a database (DB) of the information provision server, and storing and arranging advertisements or news items provided by advertiser clients in the DB of the information provision server;
a web crawler, provided in an application unit of the information provision server, collecting information stored in the DB of the information provision server, analyzing the collected information about the personal websites, and transmitting an extracted advertisement or news item to the hosting unit, thus posting the advertisement or news item in an advertisement space of a corresponding personal website;
an Internet user client searching for personal websites operated by a plurality of member clients, having the posted advertisement or news item, using the information provision server;
selecting a personal website operated by an arbitrary member client among the found personal websites operated by the plurality of member clients, and accessing the selected personal website;
the Internet user client clicking and reading the posted advertisement or news item; and
distributing profit, generated by the information provision server, to the member clients operating the personal websites as the advertisement or news item is read.

9. The profit generation method according to claim 8, wherein the web crawler provided in the application unit analyzes information posted on a corresponding personal website and extracts an advertisement or a news item suitable for the personal website from the DB provided in the information provision server.

10. The profit generation method according to claim 8, wherein the advertisement space of each personal website is constructed so that an advertisement or a news item, extracted from the DB of the information provision server by the web crawler, and an advertisement or a news item, extracted from the DB of the information provision server by letters, numerals and symbols input to an activation window, are posted in the advertisement space.

11. The profit generation method according to claim 10, wherein the activation window is constructed so that if a random advertisement selection method is selected through the activation window, the advertisement posted on personal website is selected randomly and is posted on advertisement space of the personal website.

12. The profit generation method according to claim 8, wherein the step of distributing profit, generated by the information provision server, to the member clients operating the personal websites as the advertisement or news item is read, is performed so that the plurality of member clients is paid advertisement charges by the information provision server depending on the number of clicks on a corresponding advertisement by the Internet user client.

13. The profit generation method according to claim 8, wherein the advertisement charges are distributed so that, as an advertisement or a news item is posted in the advertisement space of each personal website, the plurality of member clients is paid advertisement charges by the information provision server using a flat rate system.

14. The profit generation method according to claim 13, wherein the advertisement charges are distributed in such a way that an advertisement charge is distributed by the information provision server to a member client who has clicked an advertisement or a news item, having an event, posted on a personal website, and has executed the event.

15. The profit generation method according to claim 14, wherein the plurality of personal websites has same domain name each other.

16. A system for generating profit using a personal website, comprising:
a plurality of advertiser clients for requesting posting of advertisements or news items on personal websites and providing advertisement charges for the advertisements or news items;
a plurality of member clients for operating personal websites, on which an advertisement or a news item suitable for characteristics of the personal websites among the advertisements or news items is posted in advertisement spaces, the member clients being paid advertisement charges as the advertisements or news items are posted;
a plurality of Internet user clients for accessing a personal website, operated by an arbitrary member client found in the plurality of member clients, and reading the posted advertisement or news item; and
an information provision server for receiving advertisements or news items and advertisement charges from the plurality of advertiser clients, automatically providing an advertisement or a news item suitable for characteristics of the personal website to the personal websites, searching for member clients operating the personal websites, and distributing the advertisement charges to the member clients.

17. The profit generation system according to claim 16, wherein the information provision server comprises:
a hosting unit for managing the personal websites having advertisement spaces;
a data reception unit for receiving information posted on the personal websites and member information about the member clients;
a database (DB) for storing therein the received information posted on the personal websites and the member information;
an application unit including a web crawler for extracting an advertisement or a news item suitable for characteristics of a corresponding personal website from the information stored in the database, and matching the extracted advertisement or news item with the personal websites, a search engine for searching for the personal websites and advertisements or news items matching a keyword, entered by the Internet user clients, and a profit distribution engine for distributing advertisement charges; and
a data transmission unit for transmitting the advertisement or news item, suitable for characteristics of the personal website, to the hosting unit.

18. The profit generation system according to claim 17, wherein the hosting unit comprises:
a data reception unit for receiving the advertisements or news items transmitted from the information provision server and receiving information to be posted on the personal websites from the member clients;
a database (DB) for storing the received advertisements or news items and the information posted on the personal websites;
a web server for operating the personal websites using the advertisements or news items stored in the DB and the information posted on the personal websites; and
a data transmission unit for transmitting the information stored in the DB and posted on the personal websites to the DB of the information provision server.

19. The profit generation system according to claim 17, wherein the web crawler provided in the application unit analyzes information posted on the personal websites and extracts an advertisement or news item suitable for a corresponding personal website from the DB provided in the information provision server.

20. The profit generation system according to claim 17, wherein the personal website includes an activation window enabling random advertisements, or advertisements according to input of letters, numerals and symbols, to be posted in the advertisement space of the personal website.

21. The profit generation system according to claim 20, wherein the advertisement space is designed so that the advertisement or news item suitable for the personal website, extracted from the DB of the information provision server by the web crawler, and an advertisement or a news item extracted from the DB of the information provision server using letters, numerals or symbols input to the activation window, are posted in the advertisement space.

22. The profit generation system according to claim 21, wherein the activation window is constructed so that if a random advertisement selection method is selected through the activation window, the advertisement posted on personal website is selected randomly and is posted in advertisement space of the personal website.

23. The profit generation system according to claim 17, wherein the profit distribution engine distributes advertisement charges from the information provision server to the member clients depending on the number of clicks by respective Internet user clients on a corresponding advertisement.

24. The profit generation system according to claim 23, wherein the profit distribution engine distributes advertisement charges from the information provision server to the member clients using a flat rate system as the advertisement or news item is posted in the advertisement space of the personal website.

25. The profit generation system according to claim 24, wherein the profit distribution engine distributes the advertisement charges from the information provision server to a member client who has clicked an advertisement or a news item, having an event, posted on a personal website, and has executed the event.

26. The profit generation system according to claim 25, wherein the plurality of personal websites has same domain name each other.
